(19) United States
(12) Patent Application Publication
(10) Pub. No.: US 2008/0040741 A1
(43) Pub. Date: Feb. 14, 2008

(54) Content delivery system

(75) Inventor: Kiyoto Matsumoto, Tokyo (JP)

Correspondence Address: YOUNG & THOMPSON, 745 SOUTH 23RD STREET, 2ND FLOOR, ARLINGTON, VA, 22202, US

(73) Assignee: NEC CORPORATION, TOKYO (JP)

(21) Appl. No.: 11/882,986

(22) Filed: Aug. 8, 2007

(30) Foreign Application Priority Data
Aug. 9, 2006 (JP) 2006-217493

(51) Int. Cl. H04N 7/10

(52) U.S. Cl. 725/32

(57) ABSTRACT

The present invention provides a content delivery system, a delivery control method, a delivery program, and a recording medium with which a user can view a video advertisement in arbitrary timing during a delivery of content. When content is replayed in a user terminal, the information as to deliverable video advertisements is also displayed. As the user designates one of the video advertisements, the replay of the content is interrupted, and the designated video advertisement is delivered in a streaming manner. When the replay of the designated video advertisement ends, the replay of the content is resumed. The advertisement information displayed at this point is the advertisement information related to the designated video advertisement.

This application is based upon and claims the benefit of priority from Japanese patent application No. 2006-217493, filed on Aug. 9, 2006, the disclosure of which is incorporated herein in its entirety by reference.

### BACKGROUND OF THE INVENTION

1. Field of the Invention

The present invention pertains to a content delivery system, a delivery control method, a delivery program, and a recording medium, and more particularly, to a content delivery system, a delivery control method, a delivery program, and a recording method with which advertisement information is inserted in content to be delivered on demand.

2. Description of the Related Art

As networks with wider bandwidths have become more common in recent years, various network services are rapidly spreading. One of the network services involves content deliveries (streaming deliveries) by a streaming technique by which content including audio data and video data and the like is distributed to personal computers (PC) and the like, and the data can be reproduced on the PC side in real time.

Japanese Patent Application Laid-Open (JP-A) No. 2002-281483 discloses an example of conventional streaming delivery systems.

A conventional streaming delivery system includes an advertisement DB server, a content DB server, a portal server, a content processing server, and a streaming delivery server. The advertisement DB server stores streaming advertisements. The content DB server stores more than one streaming contents including the information as to the insertion points of the streaming advertisements. The portal server causes a viewer to select a streaming advertisement and streaming contents. The content processing server reads the selected streaming advertisement and streaming contents from different databases, and inserts the streaming advertisement in the streaming contents in accordance with the information as to the insertion points. The streaming delivery server delivers the streaming content having the streaming advertisement inserted therein to a user terminal device via a network.

The conventional streaming delivery system with the above structure operates as follows.

Firstly, the portal server performs a member registering operation. In the member registering operation, the portal server transmits a member registration screen to a user terminal device. A user operates the user terminal device to input a user ID, a password, and personal information, and requests a registration.

The user then operates the user terminal device to access the portal server. As the user logs on by inputting the user ID and the password, the portal server searches the content DB server, and generates a delivery content list screen. The portal server then sends the delivery content list screen to the user terminal device.

The user further operates the user terminal device to select desired content. The portal server then reads related advertisement information and an advertisement thumbnail still image from the advertisement DB server. The portal server generates an advertisement select screen and sends the advertisement select screen to the user terminal device.

Lastly, the user sets the number of advertisement insertion times and selects content advertisements to be viewed. The user then clicks a viewing start button. The streaming delivery system then inserts the selected advertisements in the selected content the number of times set by the user. The streaming delivery system then delivers the content in a streaming manner to the user terminal device.

JP-A Nos. 2004-080447 and 2004-140584 also disclose such content delivery systems. In JP-A No. 2004-080447, a technique for prompting viewers to view content with a strong impact is disclosed. In JP-A No. 2004-140584, a technique for presenting advertisements to viewers in a manner that is effective timewise.

The above conventional techniques, however, have the following problems. The first problem is that the advertising effect cannot be increased, as users cannot view video advertisements in arbitrary timing during each replay of content, and the advertisement information cannot be presented in a timely fashion to individual users in response to various requests from those individual users, though the users can designate the number and items of advertisements to be inserted in the content. This is because the advertisement insertion points are set in advance in the content, and the users cannot change the insertion points.

The second problem is that each streaming delivery service cannot be promptly started. This is because each user needs to register beforehand the information as to advertisement to be delivered.

By the technique disclosed in JP-A No. 2004-080447, each advertisement is viewed as evenly as possible, and advertisement information that is suited to the users' preferences cannot be always provided. By the technique disclosed in JP-A No. 2004-140584, advertisement content is delivered on the basis of the advertisement viewing history of each viewer, and it is impossible to cope with changes in the preferences of each user.

### SUMMARY OF THE INVENTION

An exemplary object of the invention is to provide a content delivery system, a delivery control method, a delivery program and a recording medium, with which a replay of a content is interrupted and advertisement information is replayed if the advertisement information is designated during the replay of the content, the replay of the content is resumed from the interrupted point after the replay of the advertisement information ends, and other advertisement information is displayed based on the designated advertisement information.

A content delivery system according to an exemplary aspect of the invention includes a communication terminal that is connected to a network and that requests and replays content and advertisement information, and a delivery server that is connected to the network and delivers the content and the advertisement information to the communication terminal in response to the request from the communication terminal, the content delivery system comprising: a designating unit that designates the content to be delivered in the communication terminal; an advertisement information display unit that displays advertisement information related to the content when the designated content is replayed in the communication terminal; an advertisement information designating unit that designates the advertisement information displayed on the advertisement information display unit; an advertisement information inserting unit that, when the advertisement information is designated during the replay of the content, interrupts the replay of the content and replays the advertisement information and resumes the replay of the content from the interrupted point after the replay of the advertisement information ends; and an advertisement information changing unit that changes the advertisement information displayed on the advertisement information display unit, based on the advertisement information replayed by the advertisement information inserting unit.

A delivery control method according to an exemplary aspect of the invention is utilized in a content delivery system that includes a communication terminal that is connected to a network and requests and replays content and advertisement information, and a delivery server that is connected to the network and delivers the content and the advertisement information to the communication terminal in response to the request from the communication terminal. The delivery control method includes the steps of designating the content to be delivered in the communication terminal; displaying advertisement information related to the content, when the designated content is replayed in the communication terminal; designating the displayed advertisement information; interrupting the replay of the content and replaying the advertisement information when the advertisement information is designated during the replay of the content, and resuming the replay of the content from the interrupted point after the replay of the advertisement information ends; and changing the advertisement information displayed in the displaying step, based on the advertisement information replayed in the interrupting step.

A delivery program in a computer-readable medium according to an exemplary aspect of the invention is executed in a content delivery system that includes a communication terminal that is connected to a network and requests and replays content and advertisement information, and a delivery server that is connected to the network and delivers the content and the advertisement information to the communication terminal in response to the request from the communication terminal. The delivery program causes a computer to: designate the content to be delivered in the communication terminal; display advertisement information related to the content, when the designated content is replayed in the communication terminal; designate the displayed advertisement information; interrupt the replay of the content and replay the advertisement information when the advertisement information is designated during the replay of the content, and resume the replay of the content from the interrupted point after the replay of the advertisement information ends; and change the advertisement information displayed in the displaying procedure, based on the advertisement information replayed in the interrupting procedure.

A computer-readable recording medium according to an exemplary aspect of the invention stores the delivery program.

### BRIEF DESCRIPTION OF THE DRAWINGS

Features of the disclosed embodiments will be described by way of the following detailed description with reference to the accompanying drawings in which:

FIG. 1 is a block diagram schematically showing the constitution of a content delivery system in accordance with a first embodiment of the present invention;

FIG. 2 is a flowchart showing an operation to be performed by the content delivery system in accordance with the first embodiment;

FIG. 3 shows an example of a delivery table in accordance with the first embodiment;

FIG. 4 shows an example of a video player that is replaying “content A: part 1”;

FIG. 5 shows the video player after replaying “content A: part 1” for a certain period of time;

FIG. 6 shows an example of a video player that is replaying a video advertisement 10;

FIG. 7 shows an example of a video player that is replaying “content A: part 2”;

FIG. 8 shows an example of an updated deliver table;

FIG. 9 shows an example of a video player that is replaying a video advertisement 12;

FIG. 10 schematically shows a delivery table before an update, a delivery table after the update, and the flow of the updating operation;

FIG. 11 shows an example of a delivery table in accordance with a second embodiment of the present invention;

FIG. 12 shows another example of a video player that is replaying “content A: part 1”;

FIG. 13 shows another example of a video player that is replaying “content A: part 2”:

FIG. 14 shows an example of an updated delivery table in accordance with the second embodiment; and

FIG. 15 shows an example of a video player that is replaying “content A: part 2”, starting from an interrupted point.

### DESCRIPTION OF EXEMPLARY EMBODIMENTS

An object of exemplary embodiments is to provide a streaming delivery system that achieves a high advertising effect by enabling users to view video advertisements in arbitrary timing during each replay of contents and presenting advertisement information in a timely fashion to the respective users in response to requests from the respective users. Another object of exemplary embodiments is to provide a streaming delivery system that enables each user to promptly start using a service without the need to register beforehand the information.

### First Exemplary Embodiment

The following is a description of a content delivery system, a delivery control method, a delivery program, and a recording medium with reference to the accompanying drawings. This exemplary embodiment is not limited to configurations described below, and may be modified within the scope of the present invention. In this embodiment, a streaming delivery system is used to describe a content delivery method.

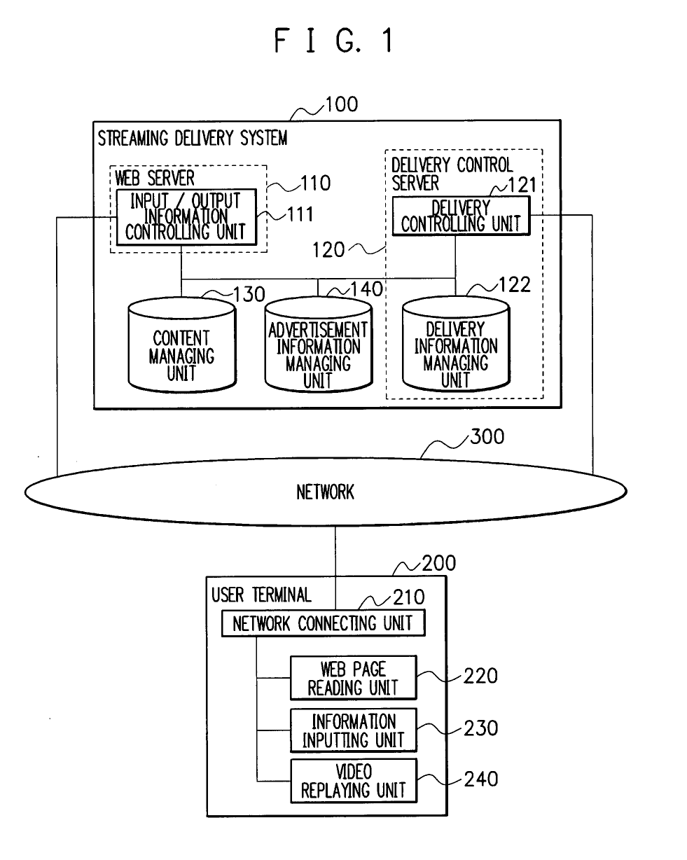

FIG. 1 schematically shows the streaming delivery system.

As shown in FIG. 1, this embodiment involves a streaming delivery system 100, a user terminal 200 and a network 300. The streaming delivery system 100 includes a Web server 110, a delivery control server 120, a content managing unit 130 and an advertisement managing unit 140. The Web server 110 includes an input/output information controlling unit 111, and the delivery control server 120 includes a delivery controlling unit 121 and a delivery information managing unit 122.

Upon receipt of a request from the user terminal 200, the input/output information controlling unit 111 of the Web server 110 transmits a menu screen of content for streaming deliveries to the user terminal 200. The input/output information controlling unit 111 also receives a designation of delivery content from the user terminal 200, and notifies the user terminal 200 of the delivery settings.

Upon receipt of a request from the user terminal 200, the delivery controlling unit 121 of the delivery control server 120 generates or updates a content delivery table, and transmits the content delivery table to the user terminal 200. The delivery controlling unit 121 also delivers various kinds of content and video advertisements to the user terminal 200. The delivery information managing unit 122 stores and manages the content delivery table generated or updated by the delivery controlling unit 121, and update history data as to various content delivery tables.

The content managing unit 130 stores and manages the various kinds of content to be delivered in a streaming manner to the user terminal 200, and information related to the content. The advertisement information managing unit 140 stores and manages various video advertisements to be delivered in a streaming manner to the user terminal 200, and information related to each of the video advertisements.

The user terminal 200 includes a network connecting unit 210, a Web page reading unit 220, an information inputting unit 230, and a video replaying unit 240.

The network connecting unit 210 connects to the streaming delivery system 100 via the network. The Web page reading unit 220 displays a Web page such as a menu screen of streaming delivery content transmitted from the Web server 110. The information inputting unit 230 inputs request information from the user terminal 200 to the streaming delivery system 100. The video replaying unit 240 replays video content or a video advertisement delivered in a streaming manner from the delivery control server 210.

The network 300 connects the streaming delivery system 100 and the user terminal 200 to each other, so that information can be exchanged between the streaming delivery system 100 and the user terminal 200. The connection may be any type of connection, regardless of whether it is a wired or wireless connection.

Next, an operation to be performed by the streaming delivery system of this embodiment is described.

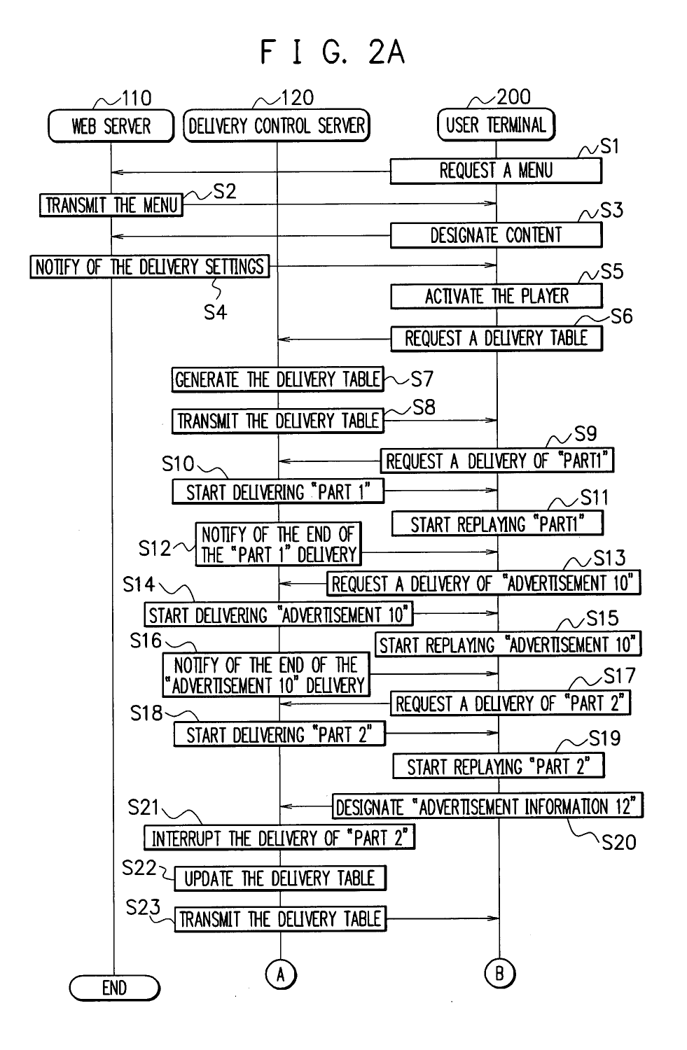

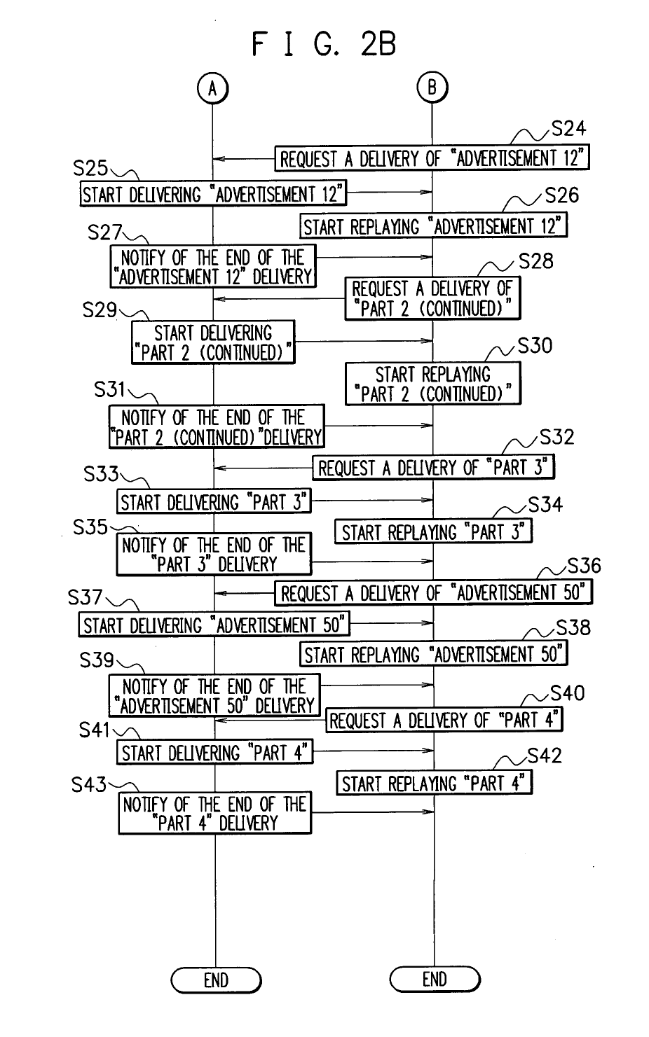

FIG. 2 is a sequence chart showing an operation to be performed by the streaming delivery system.

Firstly, a request for a menu screen of streaming delivery content is transmitted from the Web page reading unit 220 of the user terminal 200 to the Web server 110 via the network 300 (step S1). When the request is received by the input/output information controlling unit 111, the Web server 110 transmits the menu screen of streaming delivery content to the Web page reading unit 220 (step S2). A list of content items such as videos that can be viewed through streaming deliveries is displayed on the user terminal 200 (the Web page reading unit 220).

When the content list is displayed, the user terminal 200 designates content to be delivered in a streaming manner, and transmits the designation to the Web server 110 (step S3). As the request is received by the input/output information controlling unit 111, the Web server 110 notifies the user terminal 200 of the delivery settings about the designated content (step S4). The notification of the delivery settings to the user terminal 200 includes the information as to activation of a video player and a connection to the delivery control server 120. Upon receipt of the notification, the user terminal 200 activates the video player that is installed beforehand in the terminal (step S5).

After the activation of the video player, the user terminal 200 further requests the delivery controlling unit 121 of the delivery control server 120 for a delivery table associated with the designated content (step S6). Upon receipt of this request, the delivery control server 120 (the delivery controlling unit 121) refers to the information related to content and video advertisements stored in the streaming delivery system 100, and generates the delivery table associated with the designated content requested from the user terminal 200 (step S7). The information related to referred content and video advertisements is managed and stored by the content managing unit 130 and the advertisement information managing unit 140.

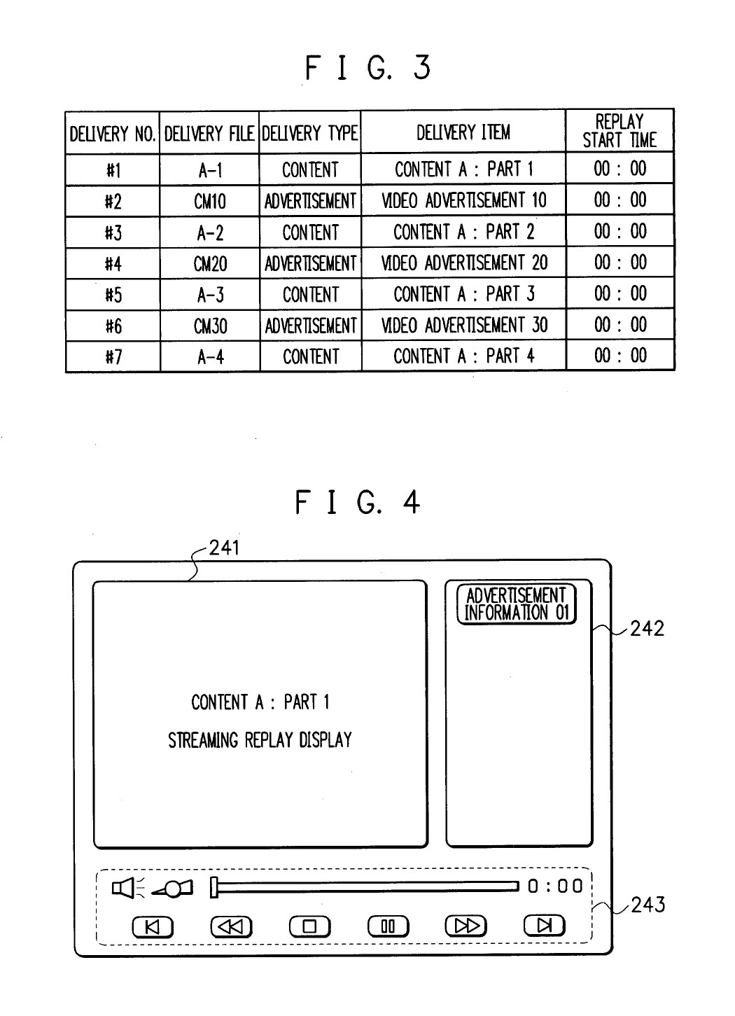

In this embodiment, three separate video advertisements are inserted in content A requested by the user terminal 200, and accordingly, the content A is divided into four portions of part 1 through part 4 to be delivered. FIG. 3 shows an example of the delivery table generated in this case.

As shown in FIG. 3, the delivery table has seven delivery files of “content A: part 1”, “video advertisement 10”, “content A: part 2”, “video advertisement 20”, “content A: part 3”, “video advertisement 30”, and “content A: part 4”, which are to be delivered in a streaming manner in that order. The replay start time for each of the delivery files is “00:00 (minute:second)”, so that all the seven delivery files are to be delivered from the top portion.

The content delivery table having such a constitution is transmitted from the delivery control server 120 to the user terminal 200 (step S8).

The user terminal 200 refers to the received content delivery table, and requests the delivery control server 120 to deliver “content A: part 1” in a streaming manner (step S9). Upon receipt of this request, the delivery control server 120 starts the streaming delivery to the user terminal 200 (step S10). The user terminal 200 receives the streaming delivery, and starts replaying “content A: part 1” with the video player (step S11). FIG. 4 shows an example of the screen displayed on the video player at this point.

In the example shown in FIG. 4, the video player replays “content A: part 1” in a streaming manner on a screen portion 241, and displays advertisement information 01 on an advertisement information display portion 242. Further, operation buttons such as a volume adjustment button, video replay and pause buttons and the like and the like, and an elapsed time display portion indicating the video replay time are displayed on an operation panel portion 243.

The advertisement information 01 displayed on the advertisement information display portion 242 is a video advertisement that can interrupt the streaming replay of “content A: part 1” being replayed on the screen portion 241, and can be replayed instead of “content A: part 1”. The advertisement information 01 may be displayed in various forms, such as a still image of the name or an exterior appearance or the sales company of the advertised product of the advertisement information 01, or a part of the advertisement information 01. When the display (the advertisement information 01) is with a mouse click by a user, the streaming replay of “content A: part 1” being replayed on the screen portion 241 is interrupted, and the advertisement information 01 is replayed in a streaming manner instead.

The data such as the displayed items of the various kinds of advertisement information to be displayed on the advertisement information display portion 242 of the video player is constituted as additional data in the streaming delivery data such as videos and voices of the content to be replayed on the screen portion 241. In other words, as the streaming replay of the content on the screen portion 241 progresses, the display of advertisement information on the advertisement information display portion 242 is updated whenever appropriate.

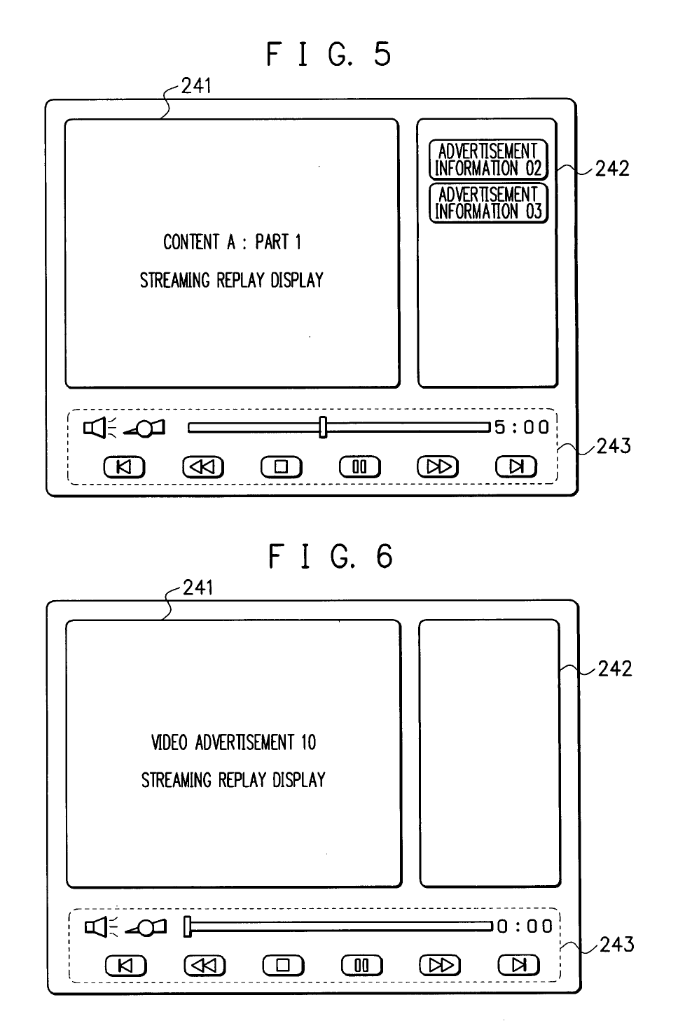

FIG. 5 shows the video player at a point when the streaming replay of “content A: part 1” on the screen portion 241 has progressed to some extent.

The example screen shown in FIG. 5 indicates that five minutes (5:00) have passed since the replay start time. The video player continues the streaming replay of “content A: part 1” on the screen portion 241, and newly displays advertisement information 02 and advertisement information 03 on the advertisement information display portion 242, instead of the advertisement information 01. This is because the most suitable advertisement to be displayed at the start of the replay is the advertisement information 01, and the most suitable advertisement(s) to be displayed at the point where five minutes have passed since the replay start is the advertisement information 02 and the advertisement information 03. As described above, the display items of the displayed advertisement information is constituted as the additional data in the streaming delivery data. Accordingly, the displayed advertisement information changes on the basis of the streaming replay data that is being replayed.

In this manner, the displayed advertisement information can be changed to advertisement information having higher appealing power, as the replay of the content proceeds from one scene to another. Accordingly, it is possible to urge the user to view the video advertisement. Thus, the maximum advertising effect can be achieved.

In this example, each of the advertisement information displayed on the advertisement information display portion 242 is not designated with a mouse click by a user or the like before the replay of “content A: part 1” is completed.

When the streaming delivery of “content A: part 1” is completed, the delivery control server 120 notifies the user terminal 200 that the delivery is completed (step S12). Upon receipt of the notification, the user terminal 200 again refers to the content delivery table shown in FIG. 3, and requests the delivery control server 120 to deliver the video advertisement 10 (step S13). After the delivery of the video advertisement 10 is completed, the user can view “content A: part 2” and the following parts.

Upon receipt of the request for a delivery of the video advertisement 10, the delivery control server 120 starts delivering the video advertisement 10 in a streaming manner to the user terminal 200 (step S14). Receiving the delivery, the user terminal 200 starts replaying the video advertisement 10 on the video player (step S15). FIG. 6 shows an example of the screen of the video player at this point.

In the example of the screen shown in FIG. 6, the video player replays the video advertisement 10 in a streaming manner on the screen portion 241, and displays operation buttons such as a volume adjustment button, video replay and pause buttons and the like and the like, and an elapsed time display portion indicating the video replay time on the operation panel portion 243.

During a replay of a video advertisement, the fast-forwarding and skipping buttons on the operation panel portion 243 do not function, and the rest of the content can be replayed only after the video advertisement is replayed to the end. Meanwhile, the advertisement information display portion 242 does not display advertisement information during a replay of a video advertisement.

When the streaming delivery of the video advertisement 10 from the delivery control server 120 is completed, a delivery end notification is sent to the user terminal 200 (step S16). When the delivery of the video advertisement 10 is completed, the user terminal 200 again refers to the content delivery table, and requests the delivery control server 120 to deliver “content A: part 2” in a streaming manner (step S17).

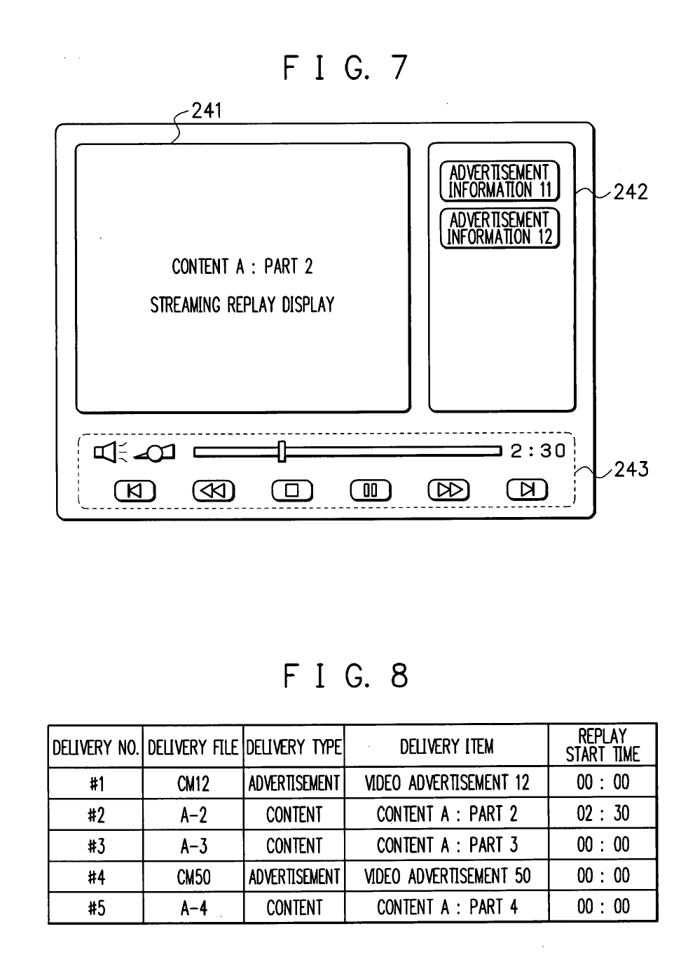

Upon receipt of this request, the delivery control server 120 starts delivering “content A: part 2” in a streaming manner to the user terminal 200 (step S18). Receiving the streaming delivery, the user terminal 200 starts replaying “content A: part 2” with the video player (step S19). FIG. 7 shows an example of the screen display of the video player at this point.

In the example of the screen shown in FIG. 7, the video player replays “content A: part 2” in a streaming manner on the screen portion 241. Advertisement information 11 and advertisement information 12 are displayed on the advertisement information display portion 242. Operation buttons such as a volume adjustment button, video replay and pause buttons and the like, and an elapsed time display portion indicating the video replay time are displayed on the operation panel portion 243. Here, the advertisement information 11 and the advertisement information 12 displayed on the advertisement information display portion 242 are video advertisements that can interrupt the streaming replay of “content A: part 2” being replayed on the screen portion 241, and can be replayed instead of “content A: part 2”.

At a point where “content A: part 2” has been replayed from the top in a streaming manner for two minutes and thirty seconds, the advertisement information 12 displayed on the advertisement information display portion 242 of the video player is selected or designated with a mouse click by a user or the like (step S20). At the same time, the user terminal 200 notifies the delivery control server 120 of the selection or designation of the advertisement information 12, and sends the data about the replay interruption time of “content A: part 2” to the delivery control server 120. The replay interruption time is two minutes and thirty seconds (2:30), which is the replay time of “content A: part 2” at the point when the display of the advertisement information 12 is designated with the click.

Upon receipt of the notifications about the designation of the advertisement information 12 and the replay interruption time of “content A: part 2”, the delivery control server 120 stops the streaming delivery of “content A: part 2” to the user terminal 200 (step S21).

At this point, the delivery control server 120 updates the content delivery table that manages streaming deliveries to the user terminal 200 (step S22). FIG. 8 shows an example of the updated content delivery table.

As shown in FIG. 8, the example of the delivery table has five delivery files of “video advertisement 12”, “content A: part 2”, “content A: part 3”, “video advertisement 50”, and “content A: part 4”, which are to be delivered in a streaming manner in that order. In the updated content deliver table shown in FIG. 8, only the replay start time of “content A: part 2” is “02:30 (minute:second)”, instead of “00:00 (minute:second)”. Accordingly, the replay start time of “content A: part 2” is set at the replay interruption time of “content A: part 2”, which is the time when the advertisement information 12 is selected and designated in step S20 described above. In this manner, a delivery of “content A: part 2” is started from the point where the display of the advertisement information 12 is selected with a click and where “content A: part 2” has been replayed from the top for two minutes and thirty seconds. Meanwhile, each of the other four delivery files is to be delivered from the top.

In the updated content delivery table, the video advertisement 20 included in the initial content delivery table prior to the update (see FIG. 3) is deleted, and the video advertisement 12 is added instead. In this manner, the total number of video advertisements to be viewed by the user during the delivery of the content is adjusted to a constant value. Accordingly, the number of video advertisements that force the user to view is reduced, and the user is prompted to actively view the advertisements. Thus, a higher advertising effect can be expected.

As the video advertisement 12 is designated by the user, the video advertisement 30 designated in the content delivery table before the update is replaced with the video advertisement 50 related to the video advertisement 12. This is because the user who has designated the video advertisement 12 is considered to be highly interested in the video advertisement 50 related to the video advertisement 12. Accordingly, the video advertisement 50 is more useful than the video advertisement 30 that is not related to the video advertisement 12, and a higher advertising effect can be expected with the video advertisement 50. The delivery control server 120 stores the update history data in the content delivery table, and provides delivery performance data as to video advertisements as the base data for advertisement accounts to advertisers, if necessary.

The delivery control server 120 transmits the updated content delivery table to the user terminal 200 (step S23). The user terminal 200 refers to the updated and received content delivery table, and requests the delivery control server 120 to deliver the video advertisement 12 in a streaming manner (step S24). As a result, a streaming delivery of the video advertisement 12 is started from the delivery control server 120 to the user terminal 200 (step S25).

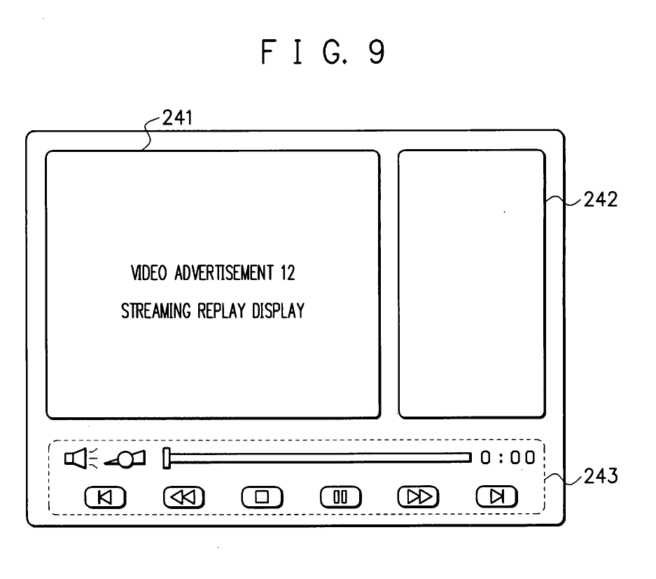

The video player of the user terminal 200 starts replaying the delivered video advertisement 12 (step S26). FIG. 9 shows an example of a screen display of the video player of the user terminal 200. In the example shown in FIG. 9, the video player replays the video advertisement 12 in a streaming manner on the screen portion 241, and displays operation buttons such as a volume adjustment button, video replay and pause buttons and the like, and the elapsed time display portion indicating the video replay time on the operation panel portion 243. During a replay of a video advertisement, the fast-forwarding and skipping buttons on the operation panel portion 243 do not function, and the rest of the content can be replayed only after the video advertisement is replayed to the end. Meanwhile, the advertisement information display portion 242 does not display advertisement information during a replay of a video advertisement.

When the streaming delivery of the video advertisement 12 is completed, the delivery control server 120 sends a delivery end notification to the user terminal 200 (step S27). When receiving the notification, the user terminal 200 refers to the content delivery table, and requests the delivery control server 120 to deliver “content A: part 2” in a streaming manner (step S28). Here, in accordance with the content delivery table, the requested streaming delivery of “content A/part 2” is resumed from the replay interrupted point where the display of the advertisement information 12 is designated with a click in step S20, or at the point of “2:30” where two minutes and thirty seconds have passed since the top of “content A/part 2”.

Upon receipt of this request, the delivery control server 120 delivers “content A: part 2”, starting from the “2:30” point, in a streaming manner to the user terminal 200 (step S29). Receiving the streaming delivery, the video player of the user terminal 200 replays “content A: part 2”, starting from the replay interrupted point (step S30).

The screen displayed on the video player of the user terminal 200 here is the same as the example screen shown in FIG. 7, and is the same as the example screen of the video player at the point when the display of the advertisement information 12 is designated with a click in step S20. The video player replays “content A: part 2” in a streaming manner on the screen portion 241. The advertisement information 11 and the advertisement information 12 are displayed on the advertisement information display portion 242. Operation buttons such as a volume adjustment button, video replay and pause buttons and the like, and an elapsed time display portion indicating the video replay time are displayed on the operation panel portion 243.

When the streaming delivery of “content A: part 2” is completed, the delivery control server 120 sends a delivery end notification to the user terminal 200 (step S31). The user terminal 200 then refers to the content delivery table, and requests the delivery control server 120 to deliver “content A: part 3” in a streaming manner (step S32).

Upon receipt of the delivery request, the delivery control server 120 starts delivering “content A: part 3” in a streaming manner to the user terminal 200 (step S33). The video player of the user terminal 200 receives the streaming delivery, and starts replaying “content A: part 3” (step S34). Here, the display of each of the advertisement information displayed on each of the advertisement information display portion 242 is not designated with a mouse click by a user or the like, before the replay of “content A: part 3” is completed.

When the streaming delivery of “content A: part 3” is completed, the delivery control server 120 sends a delivery end notification to the user terminal 200 (step S35). Upon receipt of the notification, the user terminal 200 refers to the content delivery table, and requests the delivery control server 120 to deliver the video advertisement 50 in a streaming manner (step S36). The delivery control server 120 then starts delivering the video advertisement 50 in a streaming manner to the user terminal 200 (step S37). The video player of the user terminal 200 receives the streaming delivery, and starts replaying the video advertisement 50 (step S38). Here, during the replay of the video advertisement 50, advertisement information is not displayed on the advertisement information display portion 242.

When the streaming delivery of the video advertisement 50 is completed, the delivery control server 120 sends a delivery end notification to the user terminal 200 (step S39). Upon receipt of the notification, the user terminal 200 refers to the content delivery table, and requests the delivery control server 120 to deliver “content A: part 4” in a streaming manner (step S40).

Upon receipt of the delivery request, the delivery control server 120 starts delivering “content A: part 4” in a streaming manner to the user terminal 200 (step S41). The video player of the user terminal 200 receives the streaming delivery, and starts replaying “content A: part 4” (step S42). Here, the display of each of the advertisement information displayed on the advertisement information display portion 242 is not designated with a click by a user operating a mouse or the like, before the replay of “content A: part 4” is completed.

Lastly, when the streaming delivery of “content A: part 4” is completed, the delivery control server 120 sends a delivery end notification to the user terminal 200 (step S43).

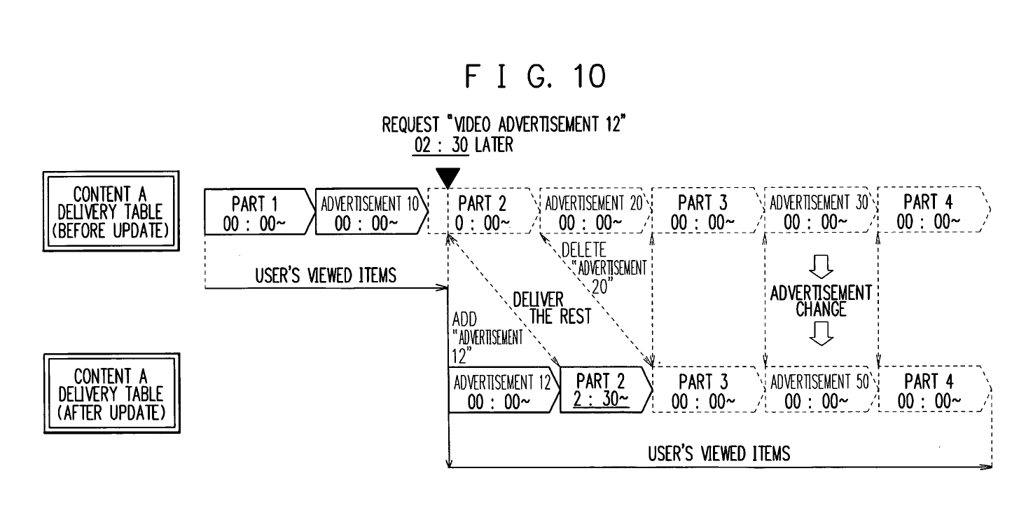

FIG. 10 schematically and collectively shows the above streaming delivery operation. The streaming delivery to the user, who views “content A” on the user terminal 200, is carried out as shown in FIG. 10.

Firstly, all of “content A; part 1” and all of the video advertisement 10 are delivered, and the delivery of “content A: part 2” is started. However, here the user designates the video advertisement 12. Therefore, the delivery of “content A: part 2” is interrupted, and the content delivery table is updated. All of the video advertisement 12 is then delivered, and the rest of “content A: part 2” is delivered. All of “content A: part 3”, all of the video advertisement 50, and all of “content A: part 4” are then delivered one by one in that order.

In the above description of this exemplary embodiment, only one delivery request for a video advertisement is made during a replay of content. However, in a case where two or more delivery requests for video advertisements are made, the delivery items should be defined by updating the content delivery table in the same manner as above. Thus, streaming deliveries in response to requests from users can be easily carried out.

As described above, the information as to video advertisements that are delivered is displayed on the advertisement information display portion 242 during a replay of content on the user terminal 200. When a user designates one of the video advertisements, the replay of content is interrupted, and the designated video advertisement is delivered in a streaming manner. After the replay of the designated video advertisement is completed, the interrupted replay of content is resumed. Accordingly, a user can view a video advertisement in arbitrary timing during a delivery of content, and timely provision of advertisement information in response to requests from individual users can be realized. Thus, the effect of delivering video advertisements can be made dramatically higher.

Furthermore, efficient operations can be performed, without the need to register beforehand the information as to the advertisements to be delivered. Accordingly, users are not bothered by complicated advance procedures, and can promptly start using the delivery services.

### Second Exemplary Embodiment

Next, a streaming delivery system of a second exemplary embodiment in accordance with the present invention is described in detail, with reference to the accompanying drawings.

The configuration of the second exemplary embodiment is the same as the constitution of the first exemplary embodiment shown in FIG. 1 described above, except that the data as to the advertisement information to be displayed during a replay of content by the video player of the user terminal 200 is not additional data in the streaming delivery data such as videos and voices of the content, but is additional data in the content delivery table to be generated and updated by the delivery control server 120. Also, the display of advertisement information on the video player is not updated with the course of a streaming replay of content, but more than one piece of advertisement information is not updated and is displayed as it is during a replay of each part of the content.

In this manner, the advertisement information is not updated with the course of a replay of content, and more than one piece of advertisement information is displayed without an update. Accordingly, each user can designate advertisement information from many choices in arbitrary timing.

Referring to FIG. 2, an operation to be performed by the streaming delivery system is described.

Firstly, a request for a menu screen of streaming delivery content is transmitted from the Web page reading unit 220 of the user terminal 200 to the Web server 110 via the network 300 (step S1). When the request is received by the input/output information controlling unit 111, the Web server 110 transmits the menu screen of streaming delivery content to the Web page reading unit 220 (step S2). A list of content items such as videos that is viewed through streaming deliveries is displayed on the user terminal 200 (the Web page reading unit 220).

When the content list is displayed, the user terminal 200 designates content to be delivered in a streaming manner, and transmits the designation to the Web server 110 (step S3). As the request is received by the input/output information controlling unit 111, the Web server 110 notifies the user terminal 200 of the delivery settings about the designated content (step S4). The notification of the delivery settings to the user terminal 200 includes the information as to activation of the video player and a connection to the delivery control server 120. Upon receipt of the notification, the user terminal 200 activates the video player that is installed beforehand in the terminal (step S5).

After the activation of the video player, the user terminal 200 further requests the delivery controlling unit 121 of the delivery control server 120 for a delivery table associated with the designated content (step S6). Upon receipt of this request, the delivery control server 120 (the delivery controlling unit 121) refers to the information related to content and video advertisements stored in the streaming delivery system 100, and generates the delivery table associated with the designated content in accordance with the request from the user terminal 200 (step S7). The information related to content and video advertisements are managed and stored by the content managing unit 130 and the advertisement information managing unit 140.

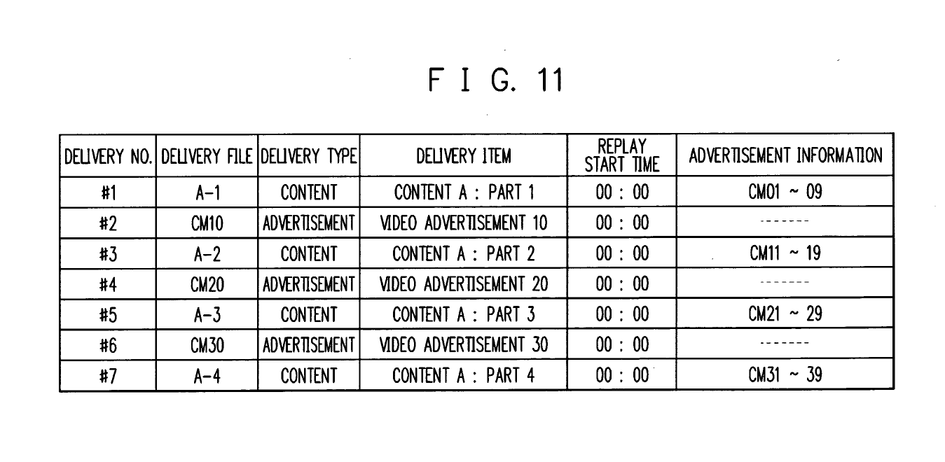

In this embodiment, three separate video advertisements are inserted in content A requested by the user terminal 200, and accordingly, the content A is divided into four portions of part 1 through part 4 to be delivered. FIG. 11 shows an example of the delivery table generated in this case.

As shown in FIG. 11, the delivery table has seven delivery files of “content A: part 1”, “video advertisement 10”, “content A: part 2”, “video advertisement 20”, “content A: part 3”, “video advertisement 30”, and “content A: part 4”, which are to be delivered in a streaming manner in that order. The replay start time for each of the delivery files is “00:00 (minute:second)”, so that all the seven delivery files are to be delivered from the top portion.

At this point, advertisement information to be simultaneously displayed during a replay of each part of “content A” is set. The advertisement information of advertisement information 01 through advertisement information 09 is displayed during the replay of “content A: part 1”. The advertisement information of advertisement information 11 through advertisement information 19 is displayed during the replay of “content A: part 2”. The advertisement information of advertisement information 21 through advertisement information 29 is displayed during the replay of “content A: part 3”. The advertisement information of advertisement information 31 through advertisement information 39 is displayed during the replay of “content A: part 4”. The content delivery table generated in this manner is transmitted from the delivery control server 120 to the user terminal 200 (step S8). At this point, the delivery control server 120 also transmits the data as to the advertisement information to be displayed during the replay of each part of “content A” to the user terminal 200.

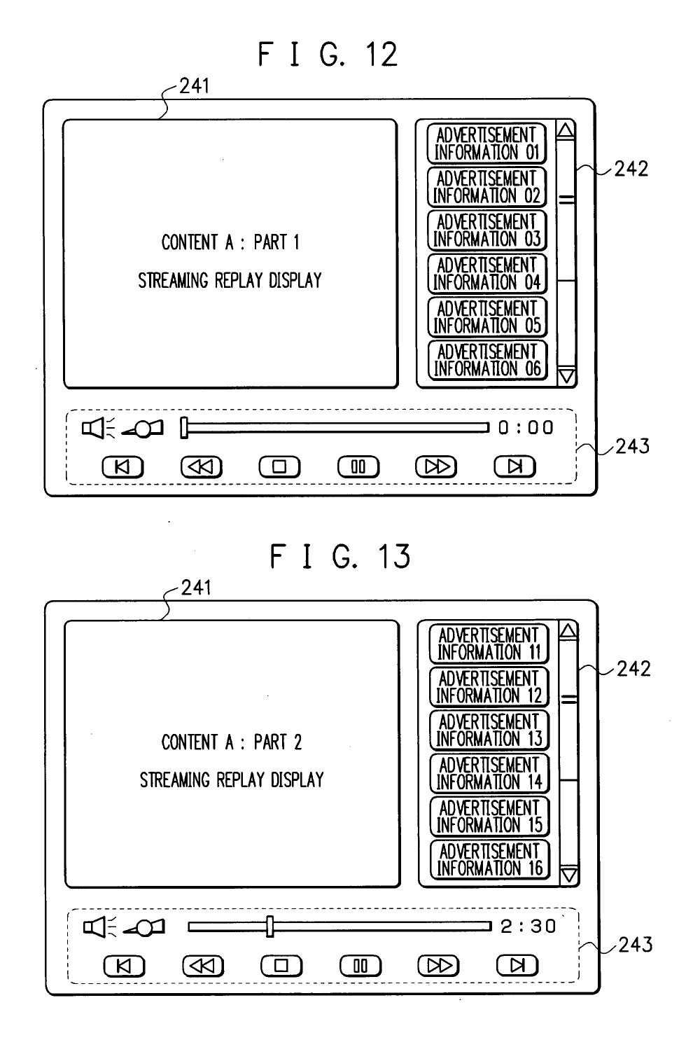

The user terminal 200 refers to the received content delivery table, and requests the delivery control server 120 to deliver “content A: part 1” in a streaming manner (step S9). Upon receipt of this request, the delivery control server 120 starts the streaming delivery to the user terminal 200 (step S10). The user terminal 200 receives the streaming delivery, and starts replaying “content A: part 1” with the video player (step S11). FIG. 12 shows an example of the screen displayed on the video player at this point.

In the example shown in FIG. 12, the video player replays “content A: part 1” in a streaming manner on the screen portion 241, and displays the advertisement information of the advertisement information 01 through 09 on the advertisement information on the display portion 242. Further, operation buttons such as a volume adjustment button, video replay and pause buttons and the like, and an elapsed time display portion indicating the video replay time are displayed on the operation panel portion 243. If all the advertisement information cannot be displayed within the screen frame of the advertisement information display portion 242, a scroll bar is operated to scroll the screen so that all the advertisement information is displayed.

The advertisement information 01 displayed on the advertisement information display portion 242 is a video advertisement that can interrupt the streaming replay of “content A: part 1” being replayed on the screen portion 241, and can be replayed instead of “content A: part 1”. In this example, the advertisement information 01 through 09 displayed on the advertisement information display portion 242 is not designated here with a mouse click by a user or the like before the replay of “content A: part 1” is completed.

When the streaming delivery of “content A: part 1” is completed, the delivery control server 120 notifies the user terminal 200 that the delivery is completed (step S12). Upon receipt of the notification, the user terminal 200 again refers to the content delivery table shown in FIG. 11, and requests the delivery control server 120 to deliver the video advertisement 10 (step S13). After the delivery of the video advertisement 10 is completed, the user can view “content A: part 2” and the following parts.

Upon receipt of the request for a delivery of the video advertisement 10, the delivery control server 120 starts delivering the video advertisement 10 in a streaming manner to the user terminal 200 (step S14). Receiving the delivery, the user terminal 200 starts replaying the video advertisement 10 on the video player (step S15). At this point, the screen of the video player is the same as the screen shown in FIG. 6 described above.

In the example of the screen shown in FIG. 6, the video player replays the video advertisement 10 in a streaming manner on the screen portion 241, and displays operation buttons such as a volume adjustment button, video replay and pause buttons and the like, and an elapsed time display portion indicating the video replay time on the operation panel portion 243. During a replay of a video advertisement, the fast-forwarding and skipping buttons on the operation panel portion 243 do not function, and the rest of the content can be replayed only after the video advertisement is replayed to the end. Meanwhile, the advertisement information display portion 242 does not display advertisement information during a replay of a video advertisement.

When the streaming delivery of the video advertisement 10 from the delivery control server 120 is completed, a delivery end notification is sent to the user terminal 200 (step S16). When the delivery of the video advertisement 10 is completed, the user terminal 200 again refers to the content delivery table, and requests the delivery control server 120 to deliver “content A: part 2” in a streaming manner (step S17).

Upon receipt of this request, the delivery control server 120 starts delivering “content A: part 2” in a streaming manner to the user terminal 200 (step S18). Receiving the streaming delivery, the user terminal 200 starts replaying “content A: part 2” with the video player (step S19). FIG. 13 shows an example of the screen display of the video player at this point.

In the example of the screen shown in FIG. 13, the video player replays “content A: part 2” in a streaming manner on the screen portion 241. The advertisement information 11 through 19 is displayed on the advertisement information display portion 242. Operation buttons such as a volume adjustment button, video replay and pause buttons and the like, and an elapsed time display portion indicating the video replay time are displayed on the operation panel portion 243. If all the advertisement information cannot be displayed within the screen frame of the advertisement information display portion 242, a scroll bar is operated to scroll the screen so that all the advertisement information is displayed.

The advertisement information 11 through 19 displayed here on the advertisement information display portion 242 is video advertisement that can interrupt the streaming replay of “content A: part 2” being replayed on the screen portion 241, and can be replayed instead of “content A: part 2”.

At a point where “content A: part 2” has been replayed from the top in a streaming manner for two minutes and thirty seconds, the advertisement information 12 displayed on the advertisement information display portion 242 of the video player is selected or designated with a mouse click by a user or the like (step S20). At the same time, the user terminal 200 notifies the delivery control server 120 of the selection or designation of the advertisement information 12, and sends the data about the replay interruption time of “content A: part 2” to the delivery control server 120. The replay interruption time is two minutes and thirty seconds (2:30), which is the replay time of “content A: part 2” at the point when the display of the advertisement information 12 is designated with the click.

Upon receipt of the notifications about the designation of the advertisement information 12 and the replay interruption time of “content A: part 2”, the delivery control server 120 stops the streaming delivery of “content A: part 2” to the user terminal 200 (step S21).

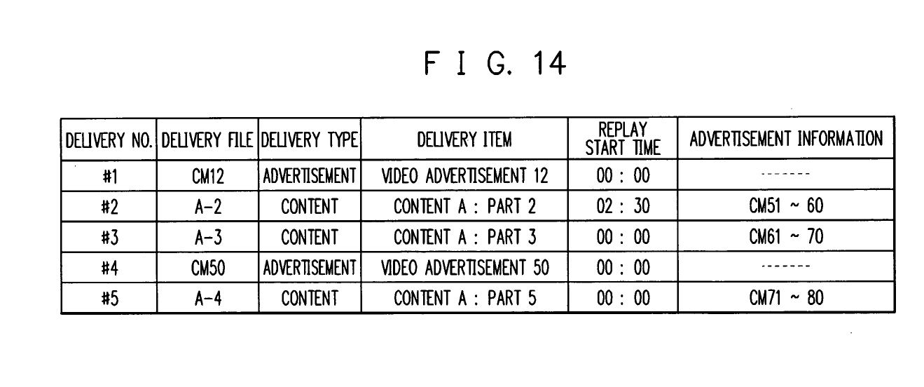

At this point, the delivery control server 120 updates the content delivery table that manages streaming deliveries to the user terminal 200 (step S22). FIG. 14 shows an example of the updated content delivery table.

As shown in FIG. 14, the example of the delivery table has five delivery files of “video advertisement 12”, “content A: part 2”, “content A: part 3”, “video advertisement 50”, and “content A: part 4”, which are to be delivered in a streaming manner in that order. In the updated content deliver table shown in FIG. 14, only the replay start time of “content A: part 2” is “02:30 (minute:second)”, instead of “00:00 (minute:second)”. Accordingly, the replay start time of “content A: part 2” is set at the replay interruption time of “content A: part 2”, which is the time when the advertisement information 12 is selected and designated in step S20 described above. In this manner, a delivery of “content A: part 2” is started from the point where the display of the advertisement information is selected with a click and where “content A: part 2” has been replayed from the top for two minutes and thirty seconds. Meanwhile, each of the other four delivery files is to be delivered from the top.

In the updated content delivery table, the video advertisement 20 included in the initial content delivery table prior to the update (see FIG. 11) is deleted, and the video advertisement 12 is designated and added by the user.

As the video advertisement 12 is designated by the user, the video advertisement 30 designated in the content delivery table before the update is replaced with the video advertisement 50 related to the video advertisement 12. According to the predetermined settings of the advertisement information to be displayed during the replay of each part of “content A”, advertisement information 51 through 60 is displayed on the advertisement information display portion 242 during the replay of “content A: part 2”. Likewise, advertisement information 61 through 70 is displayed on the advertisement information display portion 242 during the replay of “content A: part 3”, and advertisement information 71 through 80 is displayed during the replay of “content A: part 4”.

The user who views “content A” on the user terminal 200 is considered to be highly interested in “content A” and the selected and designated video advertisement 12. Accordingly, with the interests of the user being taken into account, the settings of advertisement information are controlled and adjusted so that advertisement information with which a higher advertising effect is expected is selected.

The delivery control server 120 transmits the updated content delivery table to the user terminal 200 (step S23). Here, the delivery control server 120 also transmits the data about the advertisement information to be simultaneously displayed during the replay of each part of “content A” to the user terminal 200. The user terminal 200 refers to the updated and received content delivery table, and requests the delivery control server 120 to deliver the video advertisement 12 in a streaming manner (step S24). As a result, a streaming delivery of the video advertisement 12 from the delivery control server 120 to the user terminal 200 is started (step S25).

The video player of the user terminal 200 starts replaying the delivered video advertisement 12 (step S26). The screen of the video player of the user terminal 200 at this point is the same as the screen shown in FIG. 9 described above. In the example shown in FIG. 9, the video player replays the video advertisement 12 in a streaming manner on the screen portion 241, and displays operation buttons such as a volume adjustment button, video replay and pause buttons and the like, and the elapsed time display portion indicating the video replay time on the operation panel portion 243. During a replay of a video advertisement, the fast-forwarding and skipping buttons on the operation panel portion 243 do not function, and the rest of the content can be replayed only after the video advertisement is replayed to the end. Meanwhile, the advertisement information display portion 242 does not display advertisement information during a replay of a video advertisement.

When the streaming delivery of the video advertisement 12 is completed, the delivery control server 120 sends a delivery end notification to the user terminal 200 (step S27). When receiving the notification, the user terminal 200 refers to the content delivery table, and requests the delivery control server 120 to deliver “content A: part 2” in a streaming manner (step S28). Here, in accordance with the designation of the content delivery table, the requested delivery of “content A/part 2” is resumed from the replay interrupted point where the display of the advertisement information 12 is designated with a click in step S20 described above, or at the point of “2:30” where two minutes and thirty seconds have passed since the top of “content A/part 2”.

Upon receipt of the streaming delivery request, the delivery control server 120 delivers “content A: part 2”, starting from the “2:30” point, in a streaming manner to the user terminal 200 (step S29). Receiving the streaming delivery, the video player of the user terminal 200 replays “content A: part 2”, starting from the replay interrupted point (step S30).

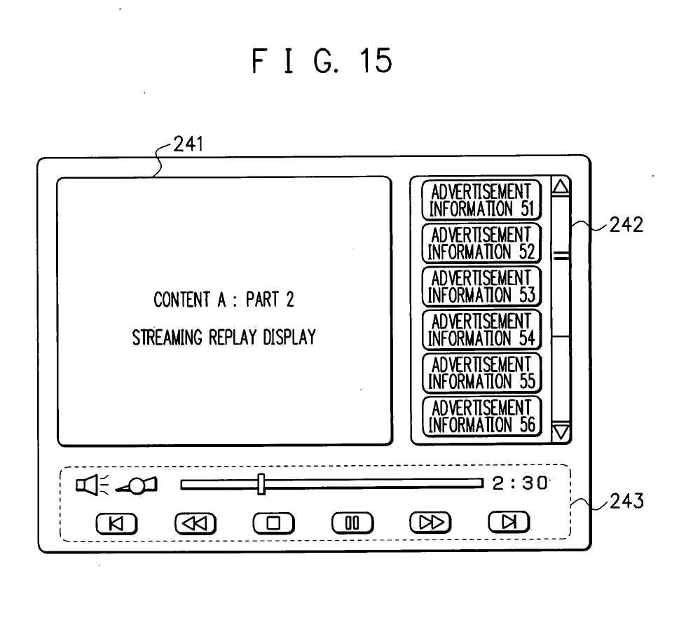

FIG. 15 shows an example of the screen displayed on the video player of the user terminal 200 at this point. The example screen shown in FIG. 15 differs from the example screen of the video player shown in FIG. 13 where the advertisement information 12 is designed with a click in step S20 described above. More specifically, the video player replays “content A: part 2” in a streaming manner on the screen portion 241, and displays the advertisement information 51 through 60 on the advertisement information display portion 242.

When the streaming delivery of “content A: part 2” is completed, the delivery control server 120 sends a delivery end notification to the user terminal 200 (step S31). The user terminal 200 then refers to the content delivery table, and requests the delivery control server 120 to deliver “content A: part 3” in a streaming manner (step S32).

Upon receipt of the delivery request, the delivery control server 120 starts delivering “content A: part 3” in a streaming manner to the user terminal 200 (step S33). The video player of the user terminal 200 receives the streaming delivery, and starts replaying “content A: part 3” (step S34). Here, the display of each of the advertisement information displayed on the advertisement information display portion 242 is not designated with a mouse click by a user or the like, before the replay of “content A: part 3” is completed.

When the streaming delivery of “content A: part 3” is completed, the delivery control server 120 sends a delivery end notification to the user terminal 200 (step S35). Upon receipt of the notification, the user terminal 200 refers to the content delivery table, and requests the delivery control server 120 to deliver the video advertisement 50 in a streaming manner (step S36). The delivery control server 120 then starts delivering the video advertisement 50 in a streaming manner to the user terminal 200 (step S37). The video player of the user terminal 200 receives the streaming delivery, and starts replaying the video advertisement 50 (step S38). Here, during the replay of the video advertisement 50, advertisement information is not displayed on the advertisement information display portion 242.

When the streaming delivery of the video advertisement 50 is completed, the delivery control server 120 sends a delivery end notification to the user terminal 200 (step S39). Upon receipt of the notification, the user terminal 200 refers to the content delivery table, and requests the delivery control server 120 to deliver “content A: part 4” in a streaming manner (step S40).

Upon receipt of the delivery request, the delivery control server 120 starts delivering “content A: part 4” in a streaming manner to the user terminal 200 (step S41). The video player of the user terminal 200 receives the streaming delivery, and starts replaying “content A: part 4” (step S42). Here, the display of the advertisement information displayed on the advertisement information display portion 242 is not designated with a mouse click by a user or the like, before the replay of “content A: part 4” is completed.

Lastly, when the streaming delivery of “content A: part 4” is completed, the delivery control server 120 sends a delivery end notification to the user terminal 200 (step S43).

In accordance with this embodiment, the data as to the advertisement information to be displayed during a replay of content on the user terminal 200 is additional data in the content delivery table, and more than one piece of advertisement information to be displayed on the advertisement information display portion 242 is displayed as it is and is not updated during the replay of each part of the content. Accordingly, users can designate advertisement information from many choices in arbitrary timing, and can actively view video advertisements. Thus, a higher advertising effect can be obtained from streaming deliveries.

Also, in this embodiment, the advertisement information displayed on the advertisement information display portion 242 of the video player of the user terminal 200 during a replay of content is advertisement information with which a higher advertising effect can be expected, with the interests of the subject user being estimated from the viewing history of the user. Accordingly, the advertising effect at the time of each streaming delivery can be maximized.

With the content delivery system, the content delivery method, the content delivery program, and the recording medium, the advertising effect in each video advertisement delivery can be maximized. This is because a user can view a video advertisement in arbitrary timing during a delivery of content, and timely provision of advertisement information in response to requests from individual users can be realized.

Furthermore, there is no need to register beforehand the information as to the advertisements to be delivered. Accordingly, users can promptly start using the services.

A third exemplary embodiment of the invention provides the content delivery system, wherein the advertisement information changing unit changes at least any one of the number of advertisements and an advertisement item in the advertisement information displayed on the advertisement information display unit.

A fourth exemplary embodiment of the invention provides the content delivery system, wherein the advertisement information to be changed by the advertisement information changing unit is advertisement information related to the advertisement information designated during the replay of the content.

A fifth exemplary embodiment of the invention provides the content delivery system, wherein the delivery server includes: a content managing unit that manages content to be delivered to the communication terminal; an advertisement information managing unit that manages advertisement information to be delivered to the communication terminal; a delivery information managing unit that manages delivery information related to the content and the advertisement information to be delivered to the communication terminal; a delivery information setting unit that sets the delivery information, based on a designation about the content or the advertisement information from the communication terminal; and a delivery control unit that controls a delivery of the delivery information.

A sixth exemplary embodiment of the invention provides the content delivery system, further including a delivery information updating unit that updates the delivery information and sets the delivery information again, when new advertisement information is designated by the advertisement information designating unit after the delivery information is set.

A seventh exemplary embodiment of the invention provides the content delivery system, wherein the communication terminal includes: a requesting unit that requests the delivery server to deliver the content or advertisement information; a replaying unit that replays the content or the advertisement information delivered from the delivery server; and an advertisement information selecting unit that selects the advertisement information displayed during the replay of the content.

An eighth exemplary embodiment of the invention provides the delivery control method, wherein the changing step includes changing at least one of the number of advertisements and an advertisement item in the advertisement information displayed in the displaying step.

A ninth exemplary embodiment of the invention provides the delivery control method, wherein the changing step includes changing the advertisement information to advertisement information related to the advertisement information designated during the replay of the content.

A tenth exemplary embodiment of the invention provides the delivery control method, including the steps of managing delivery information related to the content and the advertisement information; setting the delivery information, based on a designation about the content or the advertisement information from the communication terminal; and controlling a delivery of the delivery information.

An eleventh exemplary embodiment of the invention provides the delivery control method, further including the step of updating the delivery information and again setting the delivery information, when new advertisement information is designated in the designating step after the delivery information is set in the setting step.

A twelfth exemplary embodiment of the invention provides the delivery program, wherein the changing procedure includes changing at least one of the number of advertisements and an advertisement item in the advertisement information displayed in the displaying procedure.

A thirteenth exemplary embodiment of the invention provides the delivery program, wherein the changing procedure includes changing the advertisement information to advertisement information related to the advertisement information designated during the replay of the content.

A fourteenth exemplary embodiment provides the delivery program causing the computer to: manage delivery information related to the content and the advertisement information; set the delivery information, based on a designation about the content or the advertisement information from the communication terminal; and control a delivery of the delivery information.

A fifteenth exemplary aspect of the invention provides the delivery program further causing the computer to update the delivery information and set the delivery information again, when new advertisement information is designated in the designating procedure after the delivery information is set in the setting procedure.

A content delivery system, a content delivery method, a content delivery program, and a recording medium in accordance with the present invention may be used in free-of-charge streaming delivery services utilizing the Internet, and also be used in marketing activities utilizing the Internet.

As set forth above, an exemplary advantage according to the invention is that users can view advertisements in arbitrary timing. Also, other advertisement information is displayed on the basis of designated advertisement information. Thus, a higher advertising effect is achieved.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

1. A content delivery system comprising:
a communication terminal that is connected to a network, and requests and replays content and advertisement information;
a delivery server that is connected to the network and delivers the content and the advertisement information to the communication terminal in response to the request from the communication terminal;
a designating unit that designates the content to be delivered in the communication terminal;
an advertisement information display unit that displays advertisement information related to the content when the designated content is replayed in the communication terminal;
an advertisement information designating unit that designates the advertisement information displayed on the advertisement information display unit;
an advertisement information inserting unit that, when the advertisement information is designated during the replay of the content, interrupts the replay of the content and replays the advertisement information and resumes the replay of the content from the interrupted point after the replay of the advertisement information ends; and
an advertisement information changing unit that changes the advertisement information displayed on the advertisement information display unit, based on the advertisement information replayed by the advertisement information inserting unit.

2. The content delivery system according to claim 1, wherein the advertisement information changing unit changes at least any one of the number of advertisements and an advertisement item in the advertisement information displayed on the advertisement information display unit.

3. The content delivery system according to claim 1, wherein the advertisement information to be changed by the advertisement information changing unit is advertisement information related to the advertisement information designated during the replay of the content.

4. The content delivery system according to claim 1, wherein the delivery server comprises:
a content managing unit that manages content to be delivered to the communication terminal;
an advertisement information managing unit that manages advertisement information to be delivered to the communication terminal;
a delivery information managing unit that manages delivery information related to the content and the advertisement information to be delivered to the communication terminal;
a delivery information setting unit that sets the delivery information, based on a designation about the content or the advertisement information from the communication terminal; and
a delivery control unit that controls a delivery of the delivery information.

5. The content delivery system according to claim 1, further comprising
a delivery information updating unit that updates the delivery information and sets the delivery information again, when new advertisement information is designated by the advertisement information designating unit after the delivery information is set.

6. The content delivery system according to claim 1, wherein the communication terminal comprises:
a requesting unit that requests the delivery server to deliver the content or advertisement information;
a replaying unit that replays the content or the advertisement information delivered from the delivery server; and
an advertisement information selecting unit that selects the advertisement information displayed during the replay of the content.

7. A delivery control method to be utilized in a content delivery system that includes a communication terminal that is connected to a network and requests and replays content and advertisement information, and a delivery server that is connected to the network and delivers the content and the advertisement information to the communication terminal in response to the request from the communication terminal,
the delivery control method comprising the steps of:
designating the content to be delivered in the communication terminal;
displaying advertisement information related to the content, when the designated content is replayed in the communication terminal;
designating the displayed advertisement information;
interrupting the replay of the content and replaying the advertisement information when the advertisement information is designated during the replay of the content, and resuming the replay of the content from the interrupted point after the replay of the advertisement information ends; and
changing the advertisement information displayed in the displaying step, based on the advertisement information replayed in the interrupting step.

8. The delivery control method according to claim 7, wherein the changing step includes changing at least one of the number of advertisements and an advertisement item in the advertisement information displayed in the displaying step.

9. The delivery control method according to claim 7, wherein the changing step includes changing the advertisement information to advertisement information related to the advertisement information designated during the replay of the content.

10. The delivery control method according to claim 7, comprising the steps of:
managing delivery information related to the content and the advertisement information;
setting the delivery information, based on a designation about the content or the advertisement information from the communication terminal; and
controlling a delivery of the delivery information.

11. The delivery control method according to claim 7, further comprising the step of updating the delivery information and again setting the delivery information, when new advertisement information is designated in the designating step after the delivery information is set in the setting step.

12. A delivery program in a computer-readable medium to be executed in a content delivery system that includes a communication terminal that is connected to a network and requests and replays content and advertisement information, and a delivery server that is connected to the network and delivers the content and the advertisement information to the communication terminal in response to the request from the communication terminal,
the delivery program causing a computer to:
designate the content to be delivered in the communication terminal;
display advertisement information related to the content, when the designated content is replayed in the communication terminal;
designate the displayed advertisement information;
interrupt the replay of the content and replay the advertisement information when the advertisement information is designated during the replay of the content, and resume the replay of the content from the interrupted point after the replay of the advertisement information ends; and
change the advertisement information displayed in the displaying procedure, based on the advertisement information replayed in the interrupting procedure.

13. The delivery program according to claim 12, wherein the changing procedure includes changing at least one of the number of advertisements and an advertisement item in the advertisement information displayed in the displaying procedure.

14. The delivery program according to claim 12, wherein the changing procedure includes changing the advertisement information to advertisement information related to the advertisement information designated during the replay of the content.

15. The delivery program according to claim 12, causing the computer to:
manage delivery information related to the content and the advertisement information;
set the delivery information, based on a designation about the content or the advertisement information from the communication terminal; and
control a delivery of the delivery information.

16. The delivery program according to claim 12, further causing the computer to update the delivery information and set the delivery information again, when new advertisement information is designated in the designating procedure after the delivery information is set in the setting procedure.

17. A computer-readable recording medium on which the delivery program according to claim 12 is recorded.

18. A content delivery system comprising:
a communication terminal that is connected to a network, and requests and replays content and advertisement information;
a delivery server that is connected to the network and delivers the content and the advertisement information to the communication terminal in response to the request from the communication terminal;
designating means for designating the content to be delivered in the communication terminal;
advertisement information display means for displaying advertisement information related to the content when the designated content is replayed in the communication terminal;
advertisement information designating means for designating the advertisement information displayed on the advertisement information display means;
advertisement information inserting means for, when the advertisement information is designated during the replay of the content, interrupting the replay of the content and replaying the advertisement information and resuming the replay of the content from the interrupted point after the replay of the advertisement information ends; and
advertisement information changing means for changing the advertisement information displayed on the advertisement information display means, based on the advertisement information replayed by the advertisement information inserting means.
